(19) United States
(12) Patent Application Publication
(10) Pub. No.: US 2017/0098386 A1
(43) Pub. Date: Apr. 6, 2017

(54) GROUP WORKOUT PROCESS OVER A COMMUNICATIONS NETWORK

(71) Applicant: Ernesto Vila, Medley, FL (US)

(72) Inventor: Ernesto Vila, Medley, FL (US)

(21) Appl. No.: 14/875,386

(22) Filed: Oct. 5, 2015

(51) Int. Cl. G09B 19/00; G09B 5/00

(52) U.S. Cl. CPC G09B 19/003; G09B 5/00

(57) ABSTRACT

A method on a server for facilitating group workouts is provided. The method includes receiving and storing user profile data for users, defining a group workout, identifying a first set of users that qualify as candidates for the group workout, transmitting an invitation to the group workout to the first set of users, receiving an initiation message from a second set of users, commencing the group workout, receiving video data and telemetry data from the second set of users, executing a normalization algorithm upon the telemetry data from the users, so as to produce a performance rating for each user, and transmitting to each user said video data and said performance rating for the second set of users.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of health/fitness and, more specifically, relates to the field of managing group fitness challenges over a communications network.

### BACKGROUND

With the current obesity epidemic in the United States, fitness and weight loss efforts have been growing in popularity for Americans. The rate of obesity grew steadily from 1987 to 2007, and all states except Colorado consider at least one-fifth of their population obese. Over 72 million Americans, or one-third of the population of the United States, are considered clinically obese. One billion people around the world were considered over ideal weight. Therefore, it is not surprising that the fitness industry, including fitness centers, gyms, weight loss clinics, online fitness providers, etc., has also grown in popularity. For example, in 2008 alone, the overall fitness industry generated 9.76 billion dollars, and employed approximately 308,000 workers.

A typical gym or fitness center offers exercise equipment, from free weights to leg presses to treadmills, and may also include pools and spas, basketball and racquetball courts, personal training, massages, and classes in areas like aerobics and yoga. These amenities and offerings have historically had success in attracting customers to gyms and fitness centers. But one recent trend in the fitness industry is the change in demographics of fitness industry customers—consumers used to be concentrated fairly highly on the 18-34 range, but the popularity has spread out over all age groups, and increased particularly amongst Americans over 50 and children and teenagers. Therefore, appealing to America's aging demographic is becoming essential for the fitness industry.

One of the problems associated with attracting consumers to the fitness industry is the availability of free time. With the increasing demands on a consumer's time in modern society, many consumers can find it difficult to find the time to join a gym, drive or commute to the gym regularly, complete a workout and then drive or commute back home or elsewhere. This problem is compounded in large cities where congestion can increase commute times and limit space available in a gym. Some consumers deal with this problem by working out at home. But the home environment does not offer the same benefits as a gym or fitness center, where there is an important social aspect that motivates and inspires many consumers in their regular workouts.

Therefore, what is needed is a system and method for improving upon the problems with the prior art, and more particularly for a more efficient and mainstream way for the fitness industry to increase its appeal to a larger demographic base of customers.

### SUMMARY

A method on a server for facilitating group workouts, wherein the server is communicatively coupled to a communications network, is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method on a server for facilitating group workouts, wherein the server is communicatively coupled to a communications network, is provided that solves the above-described problems. The method includes receiving, via the communications network, user profile data for each of a plurality of users, wherein user profile data defines contact information, a time zone, a fitness level, workout behavior history, and workout preference, and storing said user profile data in an attached database, defining group workout profile data for a group workout, wherein the group workout profile data includes a time, a date, a workout type and a fitness level, identifying a first set of users from the plurality of users that qualify as candidates for the group workout, wherein a user qualifies as a candidate if the user profile data for the user matches the group workout profile data for the group workout, transmitting, via the communications network, an invitation to the group workout to each of the first set of users, using the contact information in the user profile data for each user, receiving, via the communications network, an initiation message from a second set of users, which are a subset of the first set of users, that have accepted an invitation received from the server, commencing the group workout at the time and date specified in the group workout profile data, wherein the group workout is configured according to the workout type and fitness level specified in the group workout profile data, receiving, via the communications network, video data and telemetry data from each user of the second set of users, executing a normalization algorithm upon the telemetry data from each user of the second set of users, wherein telemetry data from a user is normalized based on the user profile data of the user, so as to produce a performance rating for each user of the second set of users, and transmitting to each user of the second set of users, via the communications network, said video data and said performance rating for each user of the second set of users.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports a process for facilitating a group workout process via a server communicatively coupled with a communications network, according to an example embodiment;

FIG. 2 is a diagram showing the data flow of the group workout process, according to an example embodiment;

FIG. 3 is a diagram showing an additional data flow of the group workout process, according to an example embodiment;

FIG. 4 is a flow chart of a method for a group workout process via a server communicatively coupled with a communications network, according to an example embodiment;

FIG. 5 is a flow chart providing more detail on the processes of normalizing data, according to an example embodiment; and

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves upon the problems with the prior art by providing a system and method for allowing multiple users of a fitness program to interact with each other remotely during a group workout, thereby providing all of the benefits of an in-person group workout and all of the benefits of operating remotely using technology. The disclosed embodiments select participants for a specifically configured group workout, based on the profile data of the participants, thereby providing a group workout designed specifically for said selected group of people. During the group workout, the claimed subject matter collects and disseminates highly accurate telemetry data and video of the participants during a group workout, so that participants can compete with each other, communicate with each and benefit from the social aspect of working out in a group. Further, the claimed subject matter provides a precise and automated way to schedule, plan, organize and perform a group workout using existing technology. Thus, the claimed subject matter allows remotely located individuals to participate in a group workout using the Internet, while also experiencing the challenge and social aspects of working out in a group.

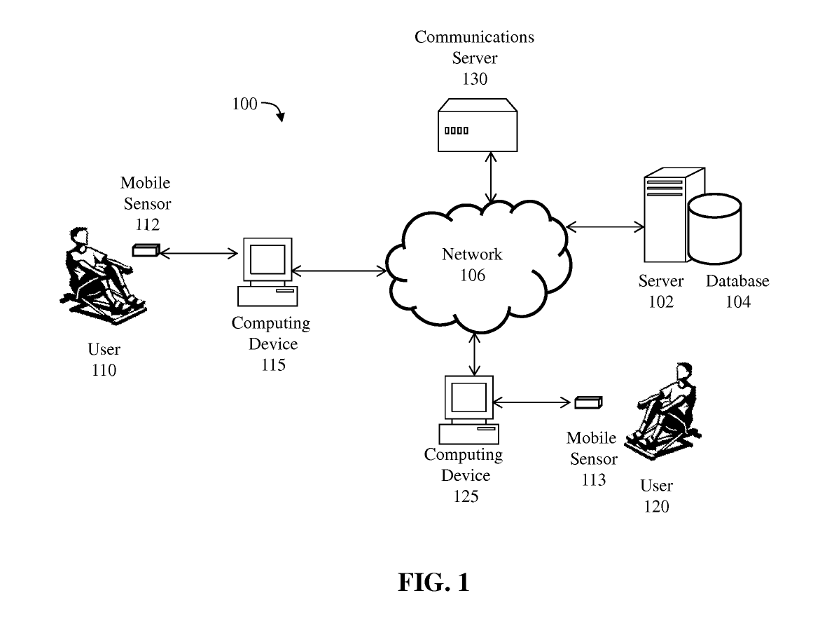

FIG. 1 is a block diagram of an operating environment 100 that supports a group workout process via a server 102 communicatively coupled with a communications network 106, according to an example embodiment. The environment 100 may comprise at least the computing devices 115, 125 and a server 102 communicating via a communications network 106. The computing devices 115, 125 may be connected either wirelessly or in a wired or fiber optic form to the communications network 106. The environment 100 may further comprise mobile activity sensors 112, 113 communicatively coupled, either wirelessly or in a wired or fiber optic form to the computing devices 115, 125. Further, environment 100 may further include communications server 130 coupled to network 106. Communications network 106 may be a packet switched network, such as the Internet, or any local area network, wide area network, enterprise private network, cellular network, phone network, mobile communications network, or any combination of the above.

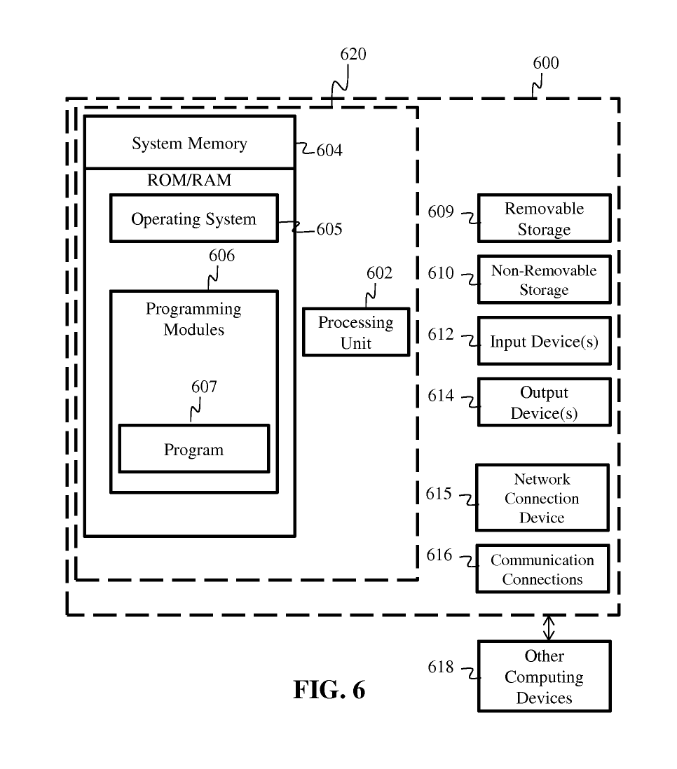

Sensors 112, 113 and computing devices 115, 125 may each comprise a computing device 600, described below in greater detail with respect to FIG. 6. Sensors 112, 113 and computing devices 115, 125 may each comprise microphones, speakers, cameras and displays for collecting, transmitting and displaying audio and video data. In one embodiment, mobile activity sensors 112, 113 may be a pedometer, accelerometer, heart rate monitor, pulse oximeter, GPS positioning device, blood pressure monitor, wattage output sensor, skin conductance sensor, breathing rate sensor and/or any other personal and wearable sensor. Said mobile activity sensors 112, 113 may record personal biometric data, and/or the activity of a user 110, 120, i.e., movement data, acceleration data, temperature data, heart rate data, pulse oximetry data, blood pressure data, wattage output data, breathing rate data, etc., all of which are referred to collectively as telemetry data. Further, sensors 112, 113 and computing devices 115, 125 may each comprise mobile computing devices such as cellular telephones, smart phones, tablet computers, or other computing devices such as a desktop computer, laptop, game console, etc. In one embodiment, the sensors 112, 113 may be integrated with computing device 115 or may be computing devices of their own (see computing device 600).

Server 102 includes a software engine that delivers applications, data, video, program code and other information to networked devices 115, 125 and 130. The software engine of server 102 may perform other processes such as transferring multimedia data, such as audio and video, in a stream of packets that are interpreted and rendered by a software application as the packets arrive. It should be noted that although FIG. 1 shows only two computing devices 115, 125 and one server 102, the system of the claimed subject matter supports any number of computing devices and servers connected via network 106.

Server 102, and computing devices 115, 125 may each include program logic comprising computer source code, scripting language code or interpreted language code that perform various functions of the claimed subject matter. In one embodiment, the aforementioned program logic may comprise program module 607 in FIG. 6.

FIG. 1 further shows that server 102 includes a database or repository 104, which may be a relational database comprising a Structured Query Language (SQL) database stored in a SQL server. Computing devices 115, 125 may also each include databases. The database 104 may serve data used by server 102, computing devices 115, 125, server 130 during the course of operation of the claimed subject matter.

Environment 100 may be used when computing devices 115, 125, as well as server 130, transfer data to and from database 104 coupled to server 102. Various types of data may be stored in the database 104 of server 102. For example, the database 104 may store one or more user records for each user, i.e., a user record or user profile that includes user profile data. A user record may include personal data for the user 110, which may include contact information for a user, a time zone of the user, a workout history of the user (fitness level of each past workout, frequency, intensity, total number of workouts, weights used, etc.), demographic data of the user (age, sex, income, race, weight, height, etc.), clinical or medical data of the user, psychological data of the user and occupational data of the user. A user record may also include assessment data for the user, wherein the assessment data includes physical fitness assessment data of the user, functional assessment data of the user, fitness level of the user, psychological assessment data of the user and economic assessment data of the user, or the like. A user record may also include preferences of the user, such as the times he prefers to work out, the types of workouts he prefers, the fitness level of the workouts he prefers, the length of the workouts, the frequency of the workouts, etc.

In another example, the database 104 may store one or more group workout records for each established group workout, i.e., a group workout record or group workout profile that includes group workout profile data. A group workout record may include a time and date for the group workout, a fitness level of the group workout, a type of the group workout, an intensity level of the group workout, a time zone of the group workout, a history of the group workout (each past workout, frequency, intensity, total number of workouts, weights used, etc.), demographic data of the participants of the group workout, a list of participants of each past group workout, a unique identifier and/or name of the group workout, a list of candidate users or participants for a group workout, etc.

Note that although server 102 is shown as a single and independent entity, in one embodiment of the claimed subject matter, the functions of server 102 may be integrated with another entity, such as the computing device 125 and the server 130. Further, server 102 and its functionality, according to a preferred embodiment, can be realized in a centralized fashion in one computer system or in a distributed fashion wherein different elements are spread across several interconnected computer systems.

FIG. 1 further shows communications server 130 communicatively coupled with the network 106. The communications server 130 comprises a server having functionality for serving video, audio and other data to users 110, 120, in an automated fashion. Communications servers are open, standards-based computing systems that operate as a carrier-grade common platform for a wide range of communications applications and allow equipment providers to add functionality to the system architecture. Communications servers are a foundational platform upon which equipment providers build network infrastructure elements for communications applications.

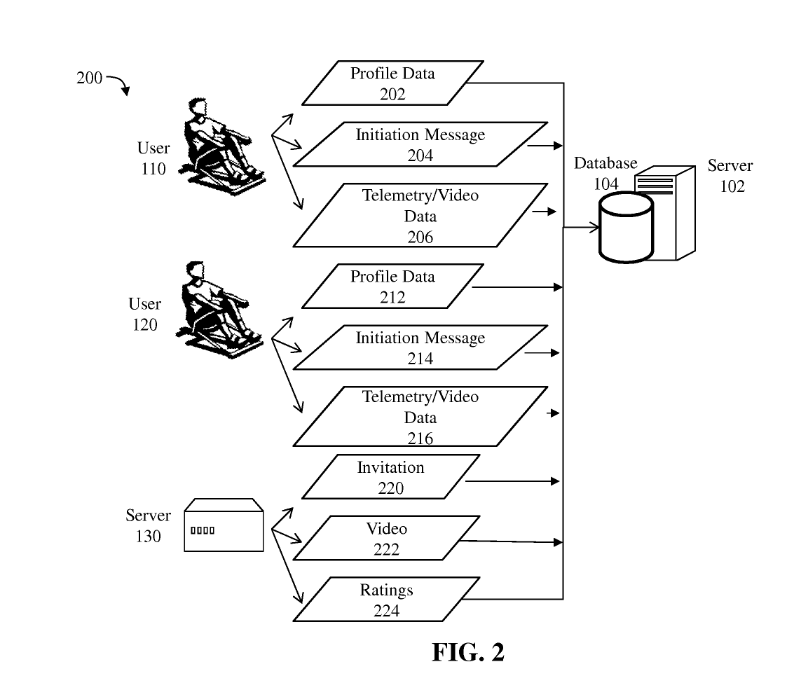

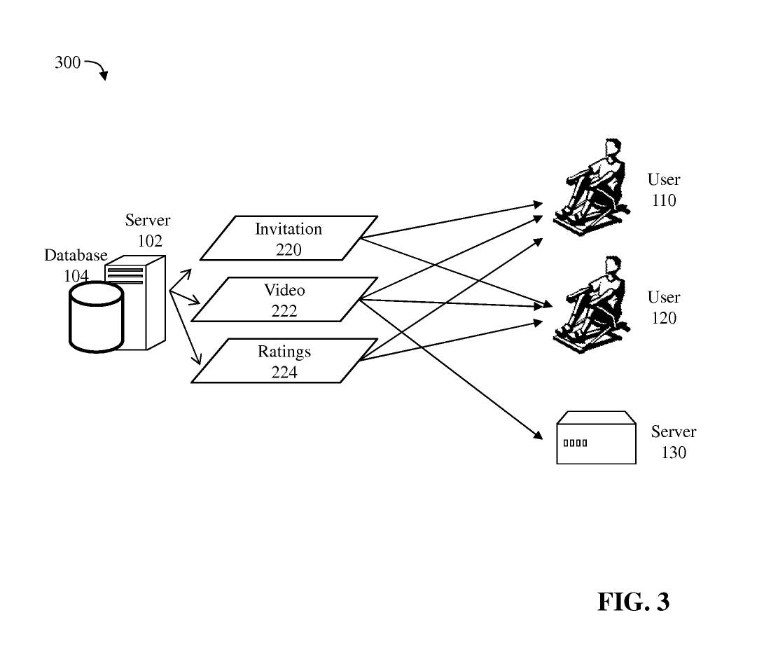

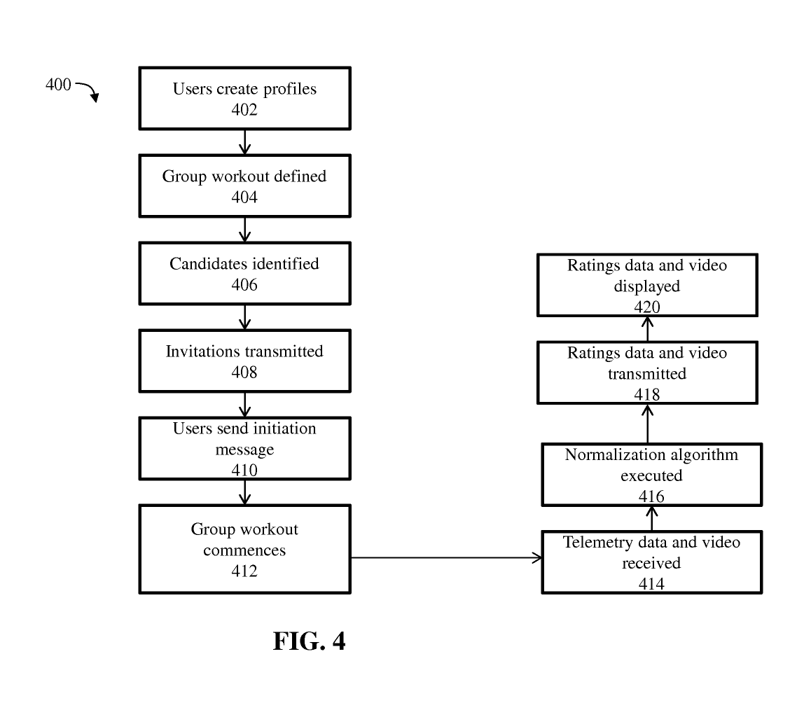

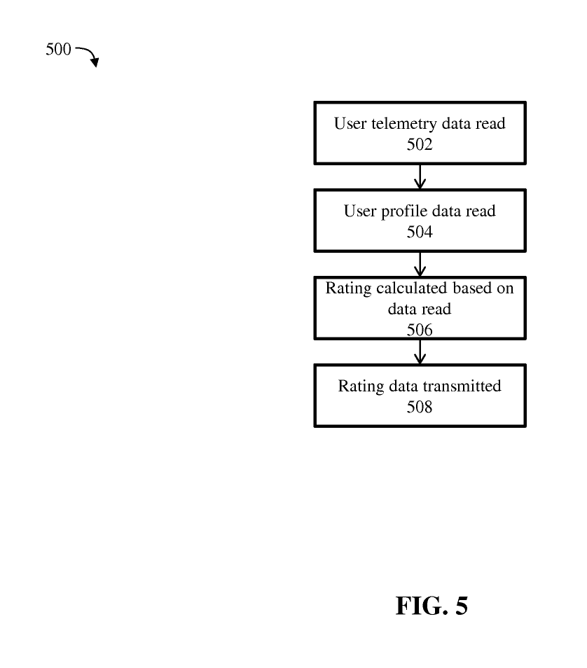

FIG. 4 is a flow chart of a method for a group workout process via a server 102 communicatively coupled with a communications network 106, according to an example embodiment. Method 400 describes the steps that occur when users 110, 120 prepare and engage in a group workout, wherein the group workout is facilitated by the use of environment 100. The method 400 is described with reference to FIG. 2, FIG. 3 and FIG. 5, which are diagrams 200 and 300 showing the data flow of the process for facilitating a group workout, and a method 500 for calculating ratings performance, according to an example embodiment.

The method 400 begins with the first step 402 wherein multiple users, such as users 110, 120, log in to server 102 (using their computing device 115) via network 106 and provide user profile data 202, 212 to server 102, which is then stored by server 102 in corresponding user records in database 104. Next, in step 404, the server 102 defines a group workout profile including group workout profile data. An administrator may define said group workout profile data. In one embodiment, the group workout is configured according to a specific workout type and fitness level, so as to customize the workout to specific users or a specific subset of users. A group workout or group challenge is an exercise program that occurs at a specified time, wherein multiple individuals participate in the program and may compete against each other or against a specified goal. Goals may include one or more of doing a certain number of repetitions of an exercise, running or cycling a specified distance, keeping a heart rate in a specified zone for a specified period of time, running or cycling for a specified period of time, etc.

Next, in step 406, the server 102 identifies a first set of users from the plurality of users that qualify as candidates for the group workout, wherein a user qualifies as a candidate if the user profile data for the user matches the group workout profile data for the group workout. In one embodiment, a user qualifies as a candidate if the workout preference and the fitness level in the user profile data of the user matches the workout type and fitness level in the group workout profile data for the group workout.

Next, in step 408, the server 102 sends, via the communications network 106, an invitation 220 to the group workout to each of the first set of users, using the contact information in the user profile data for each user. The invitation 220 may be an email or text that has a link that, when clicked, takes the user to a web site or web page that provides the data for the scheduled group workout. The invitation 220 may be sent by the server 102 or may be sent by proxy by communications server 130. In step 410, the server 102 receives, via the communications network 106, an initiation message 204, 214 from a second set of users, which are a subset of the first set of users, which subset have accepted an invitation received from the server 102. The initiation message may be an HTTP request that is transmitted in response to a user clicking on a link in the email or text comprising the invitation.

Next, in step 412, the server 102 commences the group workout at the time and date specified in the group workout profile data, wherein the group workout is configured according to the workout type and fitness level specified in the group workout profile data. In step 414, the server 102 receives in real-time, via the communications network 106, video data and telemetry data 206, 216 from each user of the second set of users. Real time transmission and reception of video and telemetry data occur at or near the actual rate at which the telemetry data and the video are collected.

In step 416, the server 102 executes a normalization algorithm upon the telemetry data from each user of the second set of users, wherein telemetry data from a user is normalized based on the user profile data of the user, so as to produce a performance rating for each user of the second set of users. See the description of FIG. 5 below for a more detailed explanation of the normalization algorithm. In one embodiment, any of the telemetry/video data 206, 216 and ratings data 224 may be stored in the user record associated with the user that originated the telemetry/video data, or in the group workout profile for the group workout.

Then, in step 418, the server 102 transmits in real-time to each user of the second set of users, via the communications network, said video data 222 and said performance rating 224 for each user of the second set of users. Alternatively, in step 418, the communications server 130 transmits in real-time to each user of the second set of users, via the communications network, said video data 222 and said performance rating 224 for each user of the second set of users. Thus, in step 420 the second set of users may then display and play the video data and the performance rating of the entire second set of users. By viewing the real time video of the other participants in the group workout and by viewing normalized ratings of the performance of each such participant, the participants in the group workout can interact with each other remotely during the group workout, thereby experiencing all of the benefits of an in-person group workout and all of the benefits of operating remotely using technology. Further, by viewing the real time video of the other participants in the group workout and by viewing normalized ratings of the performance of each such participant, the remotely located individuals participating in the group workout experience the challenge and social aspects of working out in a group.

FIG. 5 is a flow chart providing more detail on the processes of normalizing data, from step 416 above. Method 500 describes the steps that occur when server 102 calculates a numerical performance ratings value for the ratings data 224, as described above with reference to method 400. The method 500 begins with the first step 502 wherein the server 102 reads the telemetry data 206 from a user. In step 504 the server 102 reads the user profile data from the user record. In step 506, the server 102 executes a normalization algorithm upon the telemetry data from the user, wherein telemetry data from the user is normalized based on the user profile data of the user, so as to produce a performance rating for the user. The performance rating may be a numerical or alphanumeric value. The normalization algorithm comprises taking a value measured on a first scale and adjusting it to a common scale. The normalization algorithm takes into account the attributes and attribute values read from the user profile. In step 508, the server 102 transmits the performance rating data to the users.

In one example, the server 102 receives telemetry from a first user 110 (a male age 25 weighing 135 pounds) stating that he is outputting 100 watts of power. The server 102 also receives telemetry from a second user 120 (a female age 35 weighing 155 pounds) stating that she is outputting 50 watts of power. The normalization algorithm may, for example, use a normalized scale of a 35 year old male weighing 155 pounds. Thus, the normalization algorithm may take the 100 watt value for the male, deduct 10 points for his age (because he is younger than the normalized scale), deduct 10 points for his weight (because he is lighter than the normalized scale), resulting in a performance rating of 80. The normalization algorithm may take the 50 watt value for the female, add 10 points for her gender (because it is different from that for the normalized scale), add 10 points for her age (because she is older than the normalized scale), add 10 points for her weight (because she is heavier than the normalized scale), resulting in a performance rating of 80. Thus, the performance rating for both male and female are equal. This system allows people of different weight, height, fitness level, etc. to compete fairly with each other, thereby increasing the usability of the system.

FIG. 6 is a block diagram of a system including an example computing device 600 and other computing devices. Consistent with the embodiments described herein, the aforementioned actions performed by servers 102, 130, devices 112, 115, 113, 125 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for methods 400, 500 as described above. Methods 400, 500 may operate in other environments and is not limited to computing device 600.

With reference to FIG. 6, a system consistent with an embodiment of the claimed subject matter may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of servers 102, 130, devices 112, 115, 113, 125. Furthermore, embodiments of the claimed subject matter may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but are not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a network connection device 615 that may allow device 600 to communicate with other computing devices 618, such as over a network in a distributed computing environment, for example, an intranet or the Internet. Device 615 may be a wired or wireless network interface controller, a network interface card, a network interface device, a network adapter or a LAN adapter. Device 615 allows for a communication connection 616 for communicating with other computing devices 618. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of method 400's, 500's stages as described above. The aforementioned processes are examples, and processing unit 602 may perform other processes. Other programming modules that may be used in accordance with the disclosed embodiments may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, the embodiments herein may be practiced with other computer system configurations, including hand-held devices, multiprocessor systems, microprocessor-based or programmable consumer electronics, minicomputers, mainframe computers, and the like. The embodiments herein may also be practiced in distributed computing environments where tasks are performed by remote processing devices that are linked through a communications network. In a distributed computing environment, program modules may be located in both local and remote memory storage devices.

Furthermore, the embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. The embodiments herein may also be practiced using other technologies capable of performing logical operations such as, for example, AND, OR, and NOT, including but not limited to mechanical, optical, fluidic, and quantum technologies. In addition, the embodiments herein may be practiced within a general purpose computer or in any other circuits or systems.

The embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although the embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method on a server for facilitating group workouts, wherein the server is communicatively coupled to a communications network, comprising:
receiving, via the communications network, user profile data for each of a plurality of users, wherein user profile data defines contact information, a time zone, a fitness level, workout behavior history, and workout preference, and storing said user profile data in an attached database;
defining group workout profile data for a group workout, wherein the group workout profile data includes a time, a date, a workout type and a fitness level;
identifying a first set of users from the plurality of users that qualify as candidates for the group workout, wherein a user qualifies as a candidate if the user profile data for the user matches the group workout profile data for the group workout;
transmitting, via the communications network, an invitation to the group workout to each of the first set of users, using the contact information in the user profile data for each user;
receiving, via the communications network, an initiation message from a second set of users, which are a subset of the first set of users, that have accepted an invitation received from the server;
commencing the group workout at the time and date specified in the group workout profile data, wherein the group workout is configured according to the workout type and fitness level specified in the group workout profile data;
receiving, via the communications network, video data and telemetry data from each user of the second set of users;
executing a normalization algorithm upon the telemetry data from each user of the second set of users, wherein telemetry data from a user is normalized based on the user profile data of the user, so as to produce a performance rating for each user of the second set of users; and
transmitting to each user of the second set of users, via the communications network, said video data and said performance rating for each user of the second set of users.

2. The method of claim 1, wherein the user profile data further defines a user's age, sex, weight and height.

3. The method of claim 2, wherein the group workout profile data further includes a unique identifier for said group workout, and a past history of previous instances of said group workout.

4. The method of claim 3, wherein a user qualifies as a candidate if the workout preference and the fitness level in the user profile data of the user matches the workout type and fitness level in the group workout profile data for the group workout.

5. The method of claim 4, wherein an invitation is an email or a text message.

6. The method of claim 5, wherein an initiation message is an HTTP request.

7. The method of claim 6, wherein the normalization algorithm comprises taking a value measured on a first scale and adjusting it to a common scale.

8. A method on a server for facilitating group workouts, wherein the server is communicatively coupled to a communications network, comprising:
receiving, via the communications network, user profile data for each of a plurality of users, wherein user profile data defines contact information, a time zone, a fitness level, workout behavior history, and workout preference, and storing said user profile data in an attached database;
defining group workout profile data for a group workout, wherein the group workout profile data includes a time, a date, a workout type and a fitness level;
identifying a first set of users from the plurality of users that qualify as candidates for the group workout, wherein a user qualifies as a candidate if the user profile data for the user matches the group workout profile data for the group workout;
transmitting, via the communications network, an invitation to the group workout to each of the first set of users, using the contact information in the user profile data for each user;
receiving, via the communications network, an initiation message from a second set of users, which are a subset of the first set of users, that have accepted an invitation received from the server;
commencing the group workout at the time and date specified in the group workout profile data, wherein the group workout is configured according to the workout type and fitness level specified in the group workout profile data;
receiving in real-time, via the communications network, video data and telemetry data from each user of the second set of users;
executing a normalization algorithm upon the telemetry data from each user of the second set of users, wherein telemetry data from a user is normalized based on the user profile data of the user, so as to produce a performance rating for each user of the second set of users; and
transmitting in real-time to each user of the second set of users, via the communications network, said video data and said performance rating for each user of the second set of users.

9. The method of claim 8, wherein the user profile data further defines a user's age, sex, weight and height.

10. The method of claim 9, wherein the group workout profile data further includes a unique identifier for said group workout, and a past history of previous instances of said group workout.

11. The method of claim 10, wherein a user qualifies as a candidate if the workout preference and the fitness level in the user profile data of the user matches the workout type and fitness level in the group workout profile data for the group workout.

12. The method of claim 11, wherein an invitation is an email or a text message.

13. The method of claim 12, wherein an initiation message is an HTTP request.

14. The method of claim 13, wherein the normalization algorithm comprises taking a value measured on a first scale and adjusting it to a common scale.

15. A system for facilitating group workouts, the system, comprising:
a plurality of computing devices configured for recording video and telemetry data from a plurality of users, each computing device communicatively coupled to the communications network; and
a server communicatively coupled to the communications network, the server configured for:
receiving, via the communications network, user profile data for each of the plurality of users, wherein user profile data defines contact information, a time zone, a fitness level, workout behavior history, and workout preference, and storing said user profile data in an attached database;
defining group workout profile data for a group workout, wherein the group workout profile data includes a time, a date, a workout type and a fitness level;
identifying a first set of users from the plurality of users that qualify as candidates for the group workout, wherein a user qualifies as a candidate if the user profile data for the user matches the group workout profile data for the group workout;
transmitting, via the communications network, an invitation to the group workout to each of the first set of users, using the contact information in the user profile data for each user;
receiving, via the communications network, an initiation message from a second set of users, which are a subset of the first set of users, that have accepted an invitation received from the server;
commencing the group workout at the time and date specified in the group workout profile data, wherein the group workout is configured according to the workout type and fitness level specified in the group workout profile data;
receiving, via the communications network, video data and telemetry data from computing devices of the second set of users;
executing a normalization algorithm upon the telemetry data from each user of the second set of users, wherein telemetry data from a user is normalized based on the user profile data of the user, so as to produce a performance rating for each user of the second set of users; and
transmitting to each user of the second set of users, via the communications network, said video data and said performance rating for each user of the second set of users.

16. The system of claim 15, wherein the user profile data further defines a user's age, sex, weight and height.

17. The system of claim 16, wherein the group workout profile data further includes a unique identifier for said group workout, and a past history of previous instances of said group workout.

18. The method of claim 17, wherein a user qualifies as a candidate if the workout preference and the fitness level in the user profile data of the user matches the workout type and fitness level in the group workout profile data for the group workout.

19. The method of claim 18, wherein an invitation is an email or a text message.

20. The method of claim 19, wherein an initiation message is an HTTP request.
